(19) United States
(12) Patent Application Publication
(10) Pub. No.: US 2012/0069081 A1
(43) Pub. Date: Mar. 22, 2012

(54) CONVEYING DEVICE OF RECORDING MEDIUM AND IMAGE FORMING APPARATUS

(75) Inventors: Yoshiaki Kaneko, Shizuoka-ken (JP); Kazuhiro Hara, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/232,739

(22) Filed: Sep. 14, 2011

Related U.S. Application Data
(60) Provisional application No. 61/384,062, filed on Sep. 17, 2010.

(51) Int. Cl. B41J 2/015; B65H 3/18

(52) U.S. Cl. 347/20; 271/18.2

(57) ABSTRACT

According to one embodiment, the image forming apparatus has an endless device with a circumferential surface, a laminated cover which is disposed at the circumferential surface of the endless device, a rotation mechanism which rotate the endless device, a supply mechanism which supplies a recording medium to the endless device, a charging roller, a recording head unit, and a discharge mechanism. The laminated cover includes a metal layer and a dielectric layer. The metal layer has both end portions in the circumferential direction, and both side portions. The dielectric layer also has both end portions in the circumferential direction and both the side portions. At least a part of both the end portions and both the side portions of the dielectric layer has extended regions which protrude from a circumferential edge of the metal layer.

### CROSS-REFERENCE TO RELATED APPLICATIONS

This application is based upon and claims the benefit of priority from: U.S. Provisional Application No. 61/384,062 filed on Sep. 17, 2010, the entire contents of each of which are incorporated herein reference.

### FIELD

Embodiments described herein relate generally to a conveying device which conveys a recording medium such as a sheet, and an image forming apparatus.

### BACKGROUND

For example, an inkjet recording apparatus or the like includes an endless device formed of a rotating drum, or a belt, and a recording head unit which is arranged along the circumferential surface of the endless device. A recording medium is adsorbed to the circumferential surface of the endless device, and the recording medium is conveyed to the recording head unit, by a rotation of the endless device. An example of the endless device is a drum which has a dielectric layer on the circumferential surface thereof. When a charge is charged to the dielectric layer of the drum, the recording medium is adsorbed to the drum due to an electrostatic force. The rotating drum functions as a conveying device.

A drum for which a laminated cover which is formed of a metal layer and dielectric layer is provided on the circumferential surface thereof is known. In some cases, creeping discharge may occur at the circumferential edge of the laminated cover, in the laminated cover of the related art. If the charge of the dielectric layer flows to the metal layer due to the creeping discharge, the recording medium may easily separate from the drum, since the adsorption force weakens due to the static electricity.

### BRIEF DESCRIPTION OF THE DRAWINGS

FIG. 1 is a side view which schematically shows the inside of an image forming apparatus according to a first embodiment.

FIG. 2 is an enlarged side view of a part of the image forming apparatus.

FIG. 3 is a perspective view which shows a drum unit according to the first embodiment.

FIG. 4 is a cross-sectional view which schematically shows a part of the drum unit and a charge.

FIG. 5 is a cross-sectional view which schematically shows another part of the drum unit and the charge.

FIG. 6 is a cross-sectional view which shows a part of the drum unit and a separation member.

FIG. 7 is a cross-sectional view which shows a part of the drum unit according to a second embodiment.

FIG. 8 is a cross-sectional view which shows a part of the drum unit according to a third embodiment.

FIG. 9 is a perspective view which shows a drum unit according to a fourth embodiment.

FIG. 10 is a perspective view which shows a drum unit according to a fifth embodiment.

FIG. 11 is a side view which schematically shows an image forming apparatus according to a sixth embodiment.

### DETAILED DESCRIPTION

In general, according to one embodiment, the image forming apparatus includes, an endless device which has a circumferential surface, and rotates in the circumferential direction; a laminated cover which is arranged in an overlapping manner on the circumferential surface of the endless device; a rotation mechanism which rotates the endless device in a predetermined direction; a supply mechanism which supplies a recording medium to the endless device; a charging roller which charges the dielectric layer with a charge; a recording head unit which forms images on the recording medium which is adsorbed to the dielectric layer, and a discharge mechanism which discharges the recording medium on which images are formed. The laminated cover includes a metal layer and dielectric layer. The metal layer has a surface which comes into contact with the circumferential surface of the endless device, both ends portion in the circumferential direction, both sides portion, and a circumferential edge. The dielectric layer includes a surface which comes into contact with the metal layer, a both ends portion in the circumferential direction, a both sides portion, and a circumferential edge. At least a part of both end portions and both side portions of the dielectric layer protrudes from the circumferential edge of the metal layer, and has an extended region which follows the circumferential surface of the endless device.

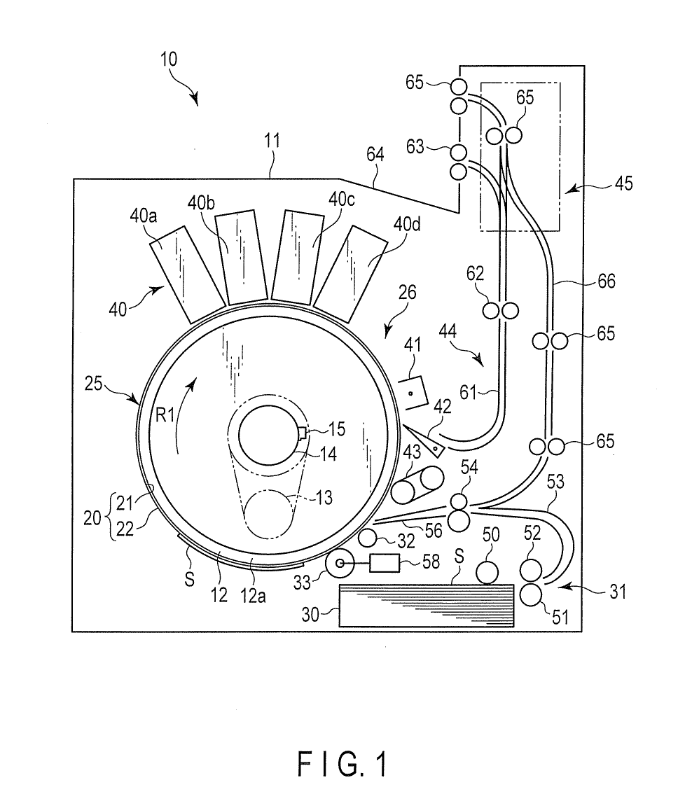

Hereinafter, the image forming apparatus according to a first embodiment will be described with reference to FIGS. 1 to 6. FIG. 1 shows an inkjet printer 10 as an example of the image forming apparatus. The inkjet printer (hereinafter referred to as a printer) 10 includes a housing 11, a drum 12 which is accommodated in the housing 11, and is an example of the endless device, and a rotation mechanism 13 which includes a motor which rotates the drum 12.

The drum 12 has a cylinder portion 12a, and rotates around an axis 14 at the predetermined circumferential speed in a direction which is shown by an arrow R1, using the rotation mechanism 13. The position of the drum 12 in the rotation direction is detected by a rotation angle sensor 15 such as an encoder. The drum 12 is formed of an electric insulative synthetic resin, and has an inner circumferential surface 12b and an external circumferential surface 12c.

A laminated cover 20, which has a metal layer 21 and a dielectric layer 22, is provided in the external circumferential surface 12c of the drum 12. The laminated cover 20 is adhered to the external circumferential surface 12c of the drum 12, by adhesion or the like. The drum 12 and the laminated cover 20 rotate together around the axis 14. A drum unit 25 which rotates around the axis 14 is configured by the drum 12 and the laminated cover 20. The rotating drum unit 25 functions as a conveying device 26 which conveys a sheet S. In addition, the laminated cover 20 will be described in detail below.

Further, the printer 10 includes a sheet receiving unit 30, a sheet supply mechanism 31, a push roller 32, a charging roller 33, a recording head unit 40, a neutralizing charger 41, a separation member 42, a cleaner 43, a discharge mechanism 44, a reversing mechanism 45, and the like. The cleaner 43 cleans the circumferential surface of the drum unit 25. The neutralizing charger 41 and separation member 42 configure a separation mechanism for separating the sheet S from the drum unit 25. The charging roller 33, the separation member 42, and the cleaner 43 include a movement mechanism for separating from the sheet S, in order not to come into contact with a surface of the sheet S on which images are formed, when the sheet S on which images are formed, passes through these units.

The sheet receiving unit 30 receives a plurality of sheets S as the recording medium. An example of the sheet S is paper with a normal size; however, it may be a resin film, a label, or the like. The sheet supply mechanism 31 includes a pick-up roller 50, a sheet supply roller 51, a separation roller 52, a sheet conveying path 53, and a pair of resist rollers 54. The sheets S which are extracted one by one using the sheet supply roller 51 and separation roller 52, are sent to the sheet conveying path 53. The leading end of the sheet S, which is sent to the sheet conveying path 53, is aligned by the pair of resist rollers 54. A guide 56 which guides the sheet S is provided between the pair of resist rollers 54 and the drum unit 25.

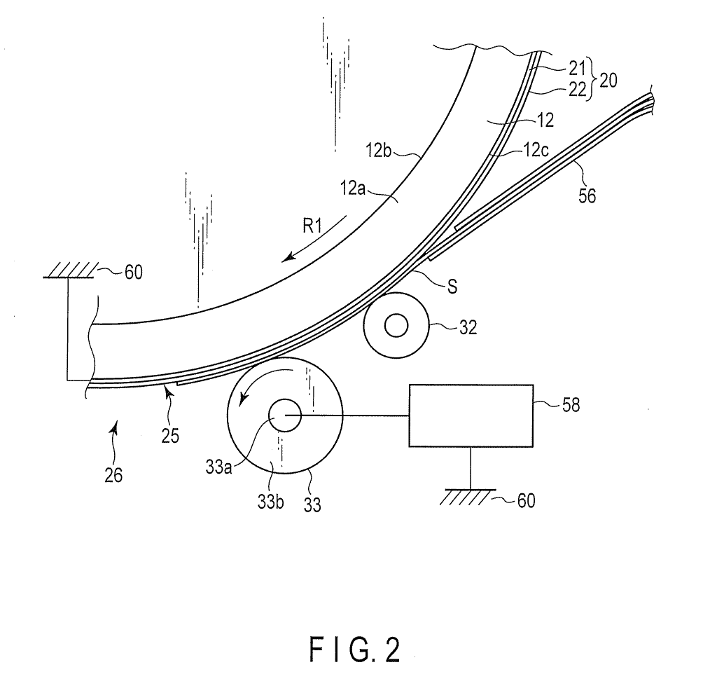

FIG. 2 shows a part of the drum unit 25, the push roller 32 and the charging roller 33, or the like. The charging roller 33 is arranged to face the dielectric layer 22 of the drum unit 25. The charging roller 33 is formed of a mandrel 33a, which is made of metal, and a conductive body 33b, which is made of a conductive material such as conductive rubber or the like and which is provided on the outer side of the mandrel 33a. A power circuit 58 is connected to the mandrel 33a. A DC voltage (for example, several thousand volts) is applied to the charging roller 33 using the power circuit 58.

The metal layer 21 of the laminated cover 20 is grounded to a ground 60. A charge e1 of a first polarity (schematically shown in FIG. 4) is charged to the surface of the dielectric layer 22 using the charging roller 33. A charge e2 of a second polarity is charged to the metal layer 21 which functions as an opposing electrode. In this manner, the potential of each part of the laminated cover 20 is maintained at 0 V.

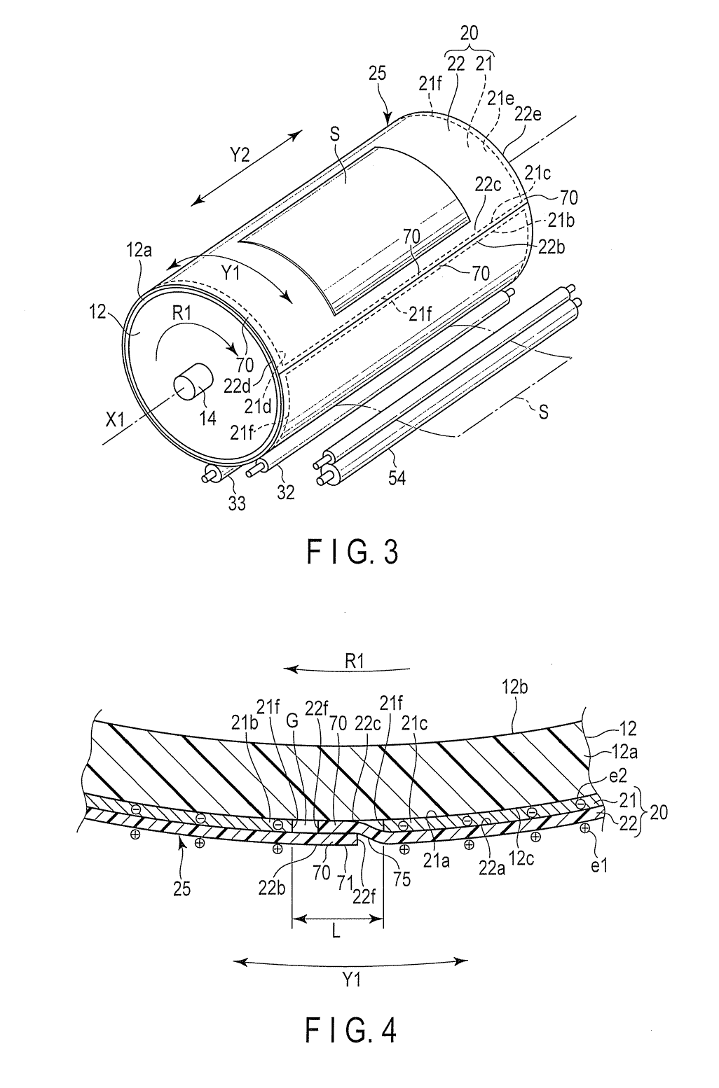

An example of the recording head unit 40 includes inkjet heads for each color 40a, 40b, 40c, and 40d which can perform color printing, using water-based ink. These inkjet heads 40a, 40b, 40c, and 40d are all line heads which extend to the drum 12 in the axis line X1 direction (shown in FIG. 3). The inkjet heads 40a, 40b, 40c, and 40d according to the embodiment include a plurality of nozzle holes (not shown) for ejecting the water-based ink. In addition, inkjet heads which use oil-based ink may be used.

An example of the inkjet heads 40a, 40b, 40c, and 40d includes a piezo element as a driving member. When applying a voltage to the piezo element, the piezo element is deformed, and when the ink is pressurized, the ink is ejected from the nozzle hole. In addition, as another example of the driving member, a heating element may be used. When the ink is heated using this heating element, the ink is ejected from the nozzle hole due to the pressure of bubbles which are generated due to the evaporation of the ink.

The discharge mechanism 44 includes a conveying guide 61, a conveying roller 62, a sheet discharge rollers 63, and a sheet discharge tray 64. A reversing mechanism 45 includes a reversing rollers 65 which reverses the sheet S, a reversing path 66, or the like.

FIG. 3 shows a drum 12, a laminated cover 20, a push roller 32, a charging roller 33, and a pair of resist rollers 54. A drum unit 25 is configured by the drum 12 and the laminated cover 20. In FIG. 3, an arrow Y1 shows a circumferential direction of the drum 12. A direction following the axis line X1 of the drum 12 (shown by an arrow Y2) is a width direction of the drum 12, that is, a width direction of the endless device.

The laminated cover 20 is overlapped with the circumferential surface 12c of the cylinder portion 12a of the drum 12, and is adhered using an adhesive. The laminated cover 20 includes a metal layer 21, for example, formed of aluminum, and a dielectric layer 22 which is arranged to be overlapped with the metal layer 21 in the thickness direction. The dielectric layer 22 is formed of a resin film, for example, such as poly fluoroethylene or PET (polyethylene terephthalate), or the like.

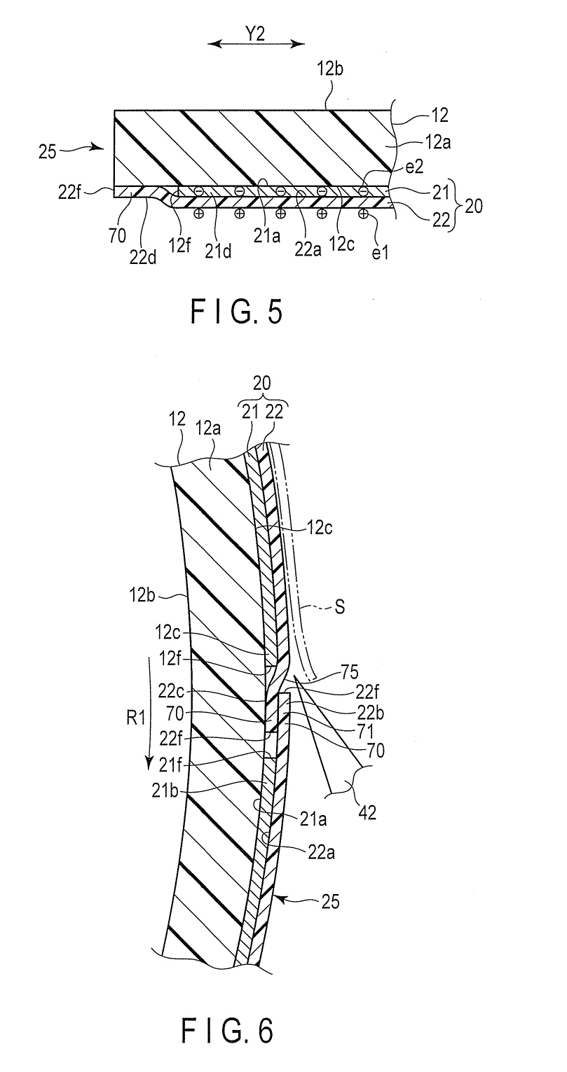

The metal layer 21 includes a surface 21a (shown in FIG. 4 and FIG. 5) which comes into contact with the circumferential surface 12c of the drum 12. In addition, the metal layer 21 includes both ends portions 21b and 21c in the circumferential direction Y1 of the drum 12, both side portions 21d and 21e which form the right angles (90°) with respect to both end portions 21b and 21c, and a circumferential edge 21f. The circumferential edge 21f extends over the entire circumference of the metal layer 21, that is, both end portions 21b and 21c, and both side portions 21d and 21e. As shown in FIG. 4, a gap G of a length L in which the metal layer 21 is not present, is defined between both end portions 21b and 21c of the metal layer 21.

The dielectric layer 22 has a surface 22a (shown in FIG. 4 and FIG. 5) which comes into contact with the metal layer 21. In addition, this dielectric layer 22 includes both end portions 22b and 22c in the circumferential direction Y1 of the drum 12, both side portions 22d and 22e which form right angles (90°) with respect to both end portions 22b and 22c, and a circumferential edge 22f. The circumferential edge 22f extends over the entire circumference of the dielectric layer 22, that is, both end portions 22b and 22c, and both side portions 22d and 22e.

Further, this dielectric layer 22 includes an extended region 70 at both end portions 22b and 22c, and both side portions 22d and 22e, respectively. In other words, the circumferential edge 21f of the metal layer 21 is positioned in the inside of the circumferential edge 22f of the dielectric layer 22, over the entire circumference of the metal layer 21. That is, the area of the metal layer 21 is smaller than the area of the dielectric layer 22.

As shown in FIG. 4, the extended region 70 of both end portions 22b and 22c of the dielectric layer 22 is extended from the circumferential edge 21f of the metal layer 21 to the circumferential direction Y1. An overlapping structure 71 is formed by bonding each extended region 70 of both end portions 22b and 22c to each other in the thickness direction, in an overlapping manner. The overlapping structure 71 is placed in the gap G. For this reason, it is possible to prevent the overlapping structure 71 from coming into contact with the charging roller 33, the separation member 42, or the cleaner 43, when the drum unit 25 rotates in the direction of the arrow R1, and to protect the overlapping structure 71. Since a counter electrode of the dielectric layer 22 is not present in the gap G, the charge is not charged to the extended region 70. Accordingly, the creeping discharge in which the charge which is charged to the dielectric layer 22 is moved to the metal layer 21 through the circumferential edge 22f, is suppressed. In addition, in the overlapping structure 71, a slope 75 is formed in the extended region 70. This slope 75 is sloped so that a distance from the circumferential surface 12c of the drum 12 becomes large from the front side of the drum 12 in the rotation direction to the rear side.

FIG. 5 shows one side portion 22d of the dielectric layer 22 in both side portions 22d and 22e as the representation. The other side portion 22e has the same configuration. The extended region 70 of both side portions 22d and 22e of the dielectric layer 22 extends from the circumferential edge 21f of the metal layer 21 to the width direction Y2 of the drum 12. The extended region 70 of both side portions 22d and 22e is adhered to the circumferential surface 12c of the drum 12 using adhesion. Since the counter electrode is not present in the extended region 70, the creeping discharge in which the charge which is charged to the dielectric layer 22 is moved to the metal layer 21 through the circumferential edge 22f, is suppressed.

Hereinafter an outline of a printing process using the printer 10 will be described.

The sheet S, which is conveyed to the pair of resist rollers 54 from the sheet receiving unit 30 using the sheet supply mechanism 31, is temporarily stopped by the pair of resist rollers 54. After the leading end position of the sheet S is aligned using the pair of resist rollers 54, the pair of resist rollers 54 rotates again. In this manner, the sheet S is supplied to the charging roller 33 through the push roller 32.

The sheet S is interposed between the drum unit 25 and charging roller 33. A DC voltage is applied to the charging roller 33 using the power circuit 58. When the charging roller 33 comes into contact with the surface of the sheet S, a charge of the first polarity is charged to the first surface of the sheet S, and a charge of the second polarity is charged to the second surface of the sheet S. Further, the first surface of the dielectric layer 22 is charged with the charge of the first polarity, and the second surface of the dielectric layer 22 is charged with the charge of the second polarity. Due to these polarization electrodes, the sheet S is electrostatically adsorbed to the surface of the dielectric layer 22.

The sheet S moves along with the drum 12 in the rotation direction R1 of the drum 12. When performing color printing, if the sheet S reaches the first inkjet head 40a, the first color ink is ejected from the first inkjet head 40a to the sheet S. The sheet S rotates while being adsorbed to the drum 12, and reaches the second inkjet head 40b. Further, the second color ink is ejected from the second inkjet head 40b to the sheet S. In addition, when the drum 12 rotates, the third color ink is ejected from the third inkjet head 40c to the sheet S. Further, when the drum 12 rotates, the fourth color ink is ejected from the fourth inkjet head 40d to the sheet S. In this manner, an image is formed on the sheet S, during the rotation of the drum 12. That is, the printer 10 performs color printing using a multi-path process of a line-head type.

When the printing is completed, an AC voltage is applied to the sheet S on which the image is formed, using the neutralizing charger 41. In this manner, the adsorption force of the sheet S with respect to the drum 12 decreases. The sheet S is separated from the drum 12 using the separation member 42, and is discharged onto the discharge tray 64, through the conveying guide 61 and the sheet discharge roller 63.

As shown in FIG. 6, when the sheet S is separated using the separation member 42, it is considered that a tip of the separation member 42 comes into contact with the overlapping structure 71 of the dielectric layer 22. However, since the slope 75 is formed in the extended region 70 of the overlapping structure 71, the tip of the separation member 42 is prevented from being hooked to the circumferential edge 22f of the dielectric layer 22. For this reason, it is possible to prevent the overlapping structure 71 from being damaged by the separation member 42, and to prevent the separation member 42 from being damaged.

When performing double-sided printing, the first surface and second surface are reversed using the reversing mechanism 45, after forming the image using the recording head unit 40 on the first surface of the sheet S which is conveyed as the outer side. The second surface of the sheet S becomes the outer side, and is conveyed by the drum unit 25, thereby forming the image on the second surface using the recording head unit 40.

The laminated cover 20 of the drum unit 25 according to the embodiment has an extended region 70 on the entire circumference of the dielectric layer 22. That is, the counter electrode is not present in the circumferential edge 22f of the dielectric layer 22. Accordingly, the creeping discharge in which the charge which is charged to the dielectric layer 22, moves to the metal layer 21 through the circumferential edge 22f, is suppressed, and it is possible to prevent the adsorption force due to the static electricity, from decreasing. For this reason, it is possible to reliably hold the sheet S to the drum unit 25, even if the drum unit 25 rotates.

When the sheet S gets wet due to ink which is ejected to the sheet S from the recording head unit 40, a bending stress occurs in the sheet S. Even such a sheet S can be stably and reliably held using the electrostatic force of the drum unit 25. As a result, it is possible to form images with high quality at a high speed, and to prevent paper jamming.

When it is the recording head unit 40 that ejects water-based ink, since the water-based ink is a conductor, the inside of the housing 11 has an environment in which the creeping discharge easily occurs. Particularly, the sheet, on which double-sided printing is performed, is turned inside out before the water-based ink present on the imaged surface is sufficiently dried, and the imaged surface comes into contact with the dielectric layer 22. For this reason, there is a possibility that the creeping discharge may easily occur. However, in the embodiment, it is possible to effectively prevent the creeping discharge from occurring even when the double-sided printing is performed using the water-based ink, since the circumferential edge 22f of the dielectric layer 22 has the extended region 70.

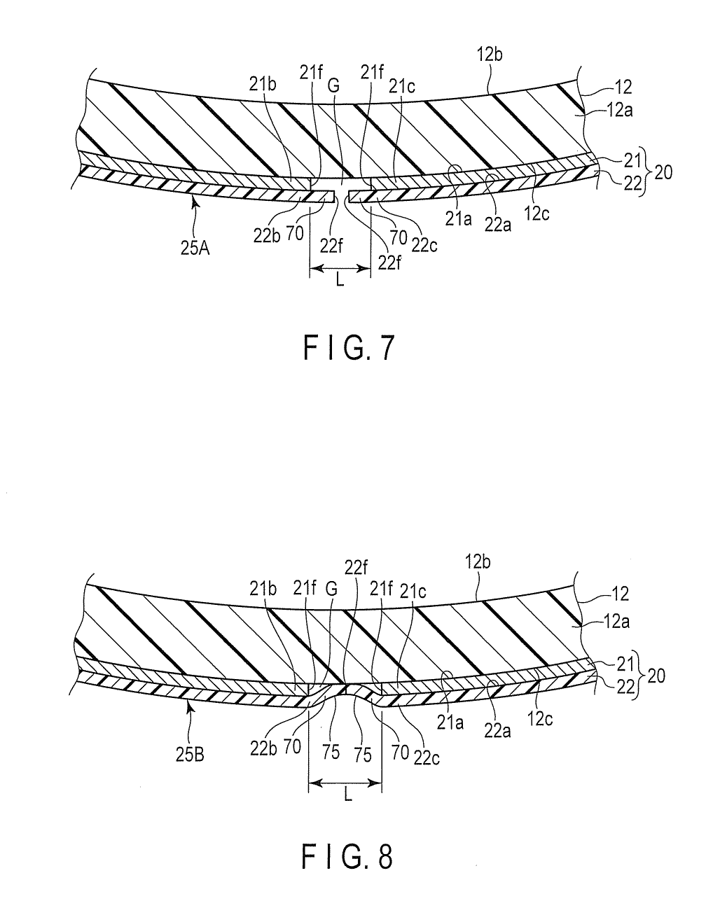

FIG. 7 shows a part of a drum unit 25A according to a second embodiment. In the drum unit 25A, extended regions 70 which are provided at both end portions 22b and 22c of a dielectric layer 22 extend in the circumferential direction of the drum 12, and face each other interposing the gap G therebetween. In the drum unit 25A, since the other configuration and operation are the same as those of the drum unit 25 according to the first embodiment, the same portions as those of the drum unit 25 are denoted by the same reference numerals, and the description thereof will be omitted.

FIG. 8 show a part of a drum unit 25B according to a third embodiment. In the drum unit 25B, extended regions 70 which are formed at both end portions 22b and 22c of the dielectric layer 22, are accommodated in a gap G. In addition, each of the extended regions 70 is connected to a circumferential surface 12c of the drum 12, in a state where the circumferential edges 22f of both end portions 22b and 22c face each other. In the drum unit 25B, since the configuration and operations are otherwise the same as those of the drum unit 25 according to the first embodiment, the same portions as those of the drum unit 25 are denoted by the same reference numerals, and the description thereof will be omitted.

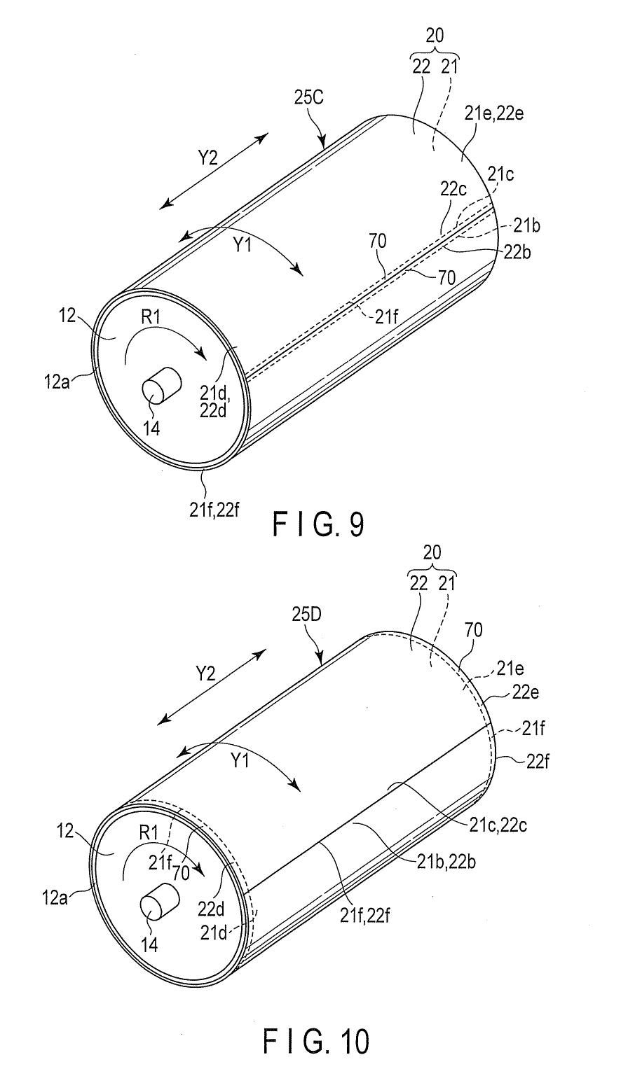

FIG. 9 is a perspective view of a drum unit 25C according to a fourth embodiment. In the embodiment, a dielectric layer 22 has extended regions 70 only at both end portions 22b and 22c of a drum 12 in the circumferential direction Y1. The extended regions 70 are not present at both side portions 22d and 22e of a dielectric layer 22, and the positions of a circumferential edge 21f of a metal layer 21 and a circumferential edge 22f of a dielectric layer 22 are aligned. In the drum unit 25C, since the configuration and operations are otherwise the same as those of the drum unit 25 according to the first embodiment, the same portions as those of the drum unit 25 are denoted by the same reference numerals, and the description thereof will be omitted.

FIG. 10 is a perspective view of a drum unit 25D according to a fifth embodiment. A dielectric layer 22 according to the embodiment has extended regions 70 at both side portions 22d and 22e. The extended regions 70 are not present at both end portions 22b and 22c of the dielectric layer 22 in the circumferential direction Y1, and the positions of a circumferential edge 21f of a metal layer 21 and a circumferential edge 22f of a dielectric layer 22 are aligned. In the drum unit 25D, since the other configuration and operation are the same as those of the drum unit 25 according to the first embodiment, the same portions as those of the drum unit 25 are denoted by the same reference numerals, and the description thereof will be omitted.

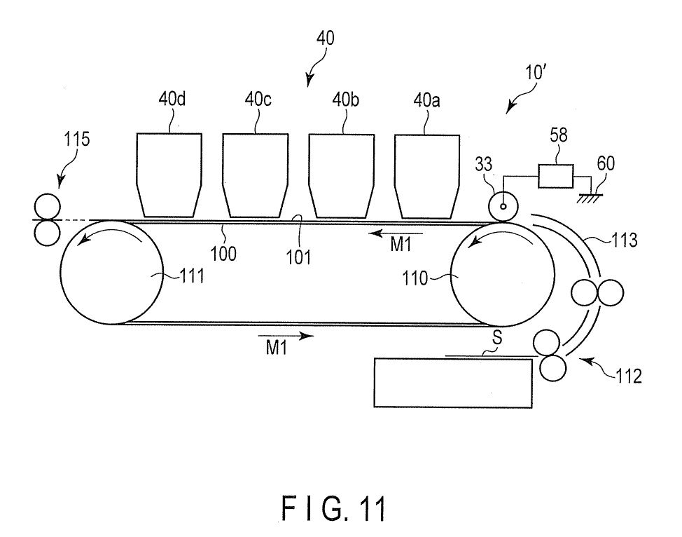

FIG. 11 shows an image forming apparatus 10′ according to a sixth embodiment. The image forming apparatus 10′ includes an endless device which is formed of a belt 100, and a laminated cover 101 which is provided at the outer circumferential surface of the belt 100. Similarly to each of the embodiments, the laminated cover 101 includes a metal layer and a dielectric layer. In addition, the laminated cover 101 has an extended region in which the circumferential edge of the dielectric layer protrudes from the circumferential edge of the metal layer, in at least a part of the entire circumference of the laminated cover 101. Due to the extended region, a creeping discharge of the dielectric layer is suppressed. The belt 100 is stretched between a first rotation body 110 and a second rotation body 111, and performs an endless rotation movement (a circulation movement) in the direction shown by an arrow M1. A charging roller 33 and a recording head unit 40 is arranged along the movement direction M1 of the belt 100. A power circuit 58 for applying a DC voltage is connected to the charging roller 33.

The sheet S shown in FIG. 11 is supplied between the laminated cover 101 on the belt 100 and the charging roller 33 from the supply mechanism 112, through the conveying path 113. The charging roller 33 applies a polarization electrode for adsorbing the sheet, to the dielectric layer of the laminated cover 101 and the sheet S. The sheet S is formed with images thereon, using inkjet heads 40a, 40b, 40c, and 40d, while being conveyed in the direction shown by the arrow M1 using the belt 100. The sheet S, on which images are formed, is discharged from a conveying mechanism 115.

As described above, it is possible to stably and reliably adsorb the sheet onto the circumferential surface of the endless device, since the creeping discharge is suppressed due to the extended region of the dielectric layer, using the printer according to each of the embodiments. The above-described embodiments may be applied to a thermal printer or a wire dot printer, in addition to the inkjet printer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A holding device of a recording medium comprising:
an endless device which has a circumferential surface, and rotates in a circumferential direction; and
a laminated cover which is arranged in an overlapping manner on the circumferential surface of the endless device, which includes, a metal layer having a surface which comes into contact with the circumferential surface of the endless device, and both end portions and both side portions in the circumferential direction, and a circumferential edge; and a dielectric layer having a surface which comes into contact with the metal layer, and both end portions and both side portions in the circumferential direction, and a circumferential edge, and has extended regions which protrude at least a part of both of the end portions and both of the side portions of the dielectric layer, from the circumferential edge of the metal layer, and follow the circumferential surface of the endless device.

2. The device according to claim 1,
wherein the laminated cover includes the extended regions which are provided at both of the end portions of the dielectric layer, respectively.

3. The device according to claim 1,
wherein the laminated cover includes the extended regions which are provided at both of the side portions of the dielectric layer, respectively.

4. The device according to claim 1,
wherein the laminated cover includes the extended regions which are provided at both of the end portions of the dielectric layer, respectively, and the extended regions which are provided at both of the side portions of the dielectric layer, respectively.

5. The device according to claim 2,
wherein an overlapping structure is formed by overlapping both of the extended regions which are provided at both of the end portions of the dielectric layer, in a thickness direction, and the overlapping structure is placed in a gap between both of the end portions of the metal layer.

6. The device according to claim 3,
wherein the extended regions which are provided at both of the side portions of the dielectric layer are respectively adhered to the circumferential surface of the endless device.

7. The device according to claim 2,
wherein the extended regions which are provided at both of the end portions of the dielectric layer, are respectively adhered to the circumferential surface of the endless device, in a gap between both of the end portions of the metal layer.

8. The device according to claim 2,
wherein the extended regions which are provided at both of the end portions of the dielectric layer, face each other in a gap between both of the end portions of the metal layer.

9. The device according to claim 1,
wherein the endless device is a cylindrical drum which has a cylinder portion, and the laminated cover is disposed at the circumferential surface of the cylinder portion of the drum.

10. The device according to claim 9,
wherein the endless device is a belt, and the laminated cover is disposed at the circumferential surface of the belt.

11. An image forming apparatus comprising:
an endless device which has a circumferential surface, and rotates in a circumferential direction;
a laminated cover which is arranged in an overlapping manner on the circumferential surface of the endless device including, a metal layer having a surface which comes into contact with the circumferential surface of the endless device, and both end portions and both side portions in the circumferential direction, and a circumferential edge; and a dielectric layer which has a surface which comes into contact with the metal layer, and both end portions and both side portions in the circumferential direction, and a circumferential edge, and has extended regions which protrude at least a part of both of the end portions and both of the side portions of the dielectric layer, from the circumferential edge of the metal layer, and follows the circumferential surface of the endless device;
a rotation mechanism which rotates the endless device in a circumferential direction;
a supply mechanism which supplies a recording medium to the endless device;
a charging roller which charges the dielectric layer of the laminated cover to adsorb the recording medium;
a recording head unit which forms images on the recording medium;
a separation mechanism which separates the recording medium on which the images are formed, from the dielectric layer; and
a discharge mechanism which discharges the recording medium which is separated from the dielectric layer.

12. The apparatus according to claim 11,
wherein the recording head unit includes inkjet heads which eject water-based ink to the recording medium.

13. The apparatus according to claim 12, further comprising:
a reversing mechanism in which first and second surfaces of the recording medium on which images are formed using the inkjet heads, are reversed to be supplied to the endless device again.

14. The apparatus according to claim 11,
wherein the laminated cover includes the extended regions which are respectively provided at both of the end portions of the dielectric layer.

15. The apparatus according to claim 11,
wherein the laminated cover includes the extended regions which are provided at both of the end portions of the dielectric layer, and are provided at both of the side portions of the dielectric layer.

16. The apparatus according to claim 14,
wherein an overlapping structure which is provided at both of the end portions of the dielectric layer, is formed by overlapping both of the extended regions with each other in the thickness direction, and the overlapping structure is placed in a gap between both of the end portions of the metal layer.

17. The apparatus according to claim 16,
wherein the separation mechanism includes a neutralizing charger which neutralizes the charge on the recording sheet, and the separation member which separates the recording medium which is neutralized using the neutralizing charger, from the dielectric layer.

18. The apparatus according to claim 17,
wherein the overlapping structure has a slope which increases a distance from the circumferential surface of the endless device, from the front side of the endless device in the rotation direction to the rear side.
